(19) United States
(12) Patent Application Publication
(10) Pub. No.: US 2026/0189119 A1
(43) Pub. Date: Jul. 2, 2026

(54) MAGNETIC GEAR DEVICE

(71) Applicant: Mitsubishi Electric Corporation, Tokyo (JP)

(72) Inventors: Kodai OKAZAKI, Tokyo (JP); Junji KITAO, Tokyo (JP)

(73) Assignee: Mitsubishi Electric Corporation, Tokyo (JP)

(21) Appl. No.: 18/868,190

(22) PCT Filed: Jun. 1, 2022
(86) PCT No.: PCT/JP2022/022284

§ 371 Date: Nov. 22, 2024

(51) Int. Cl. H02K 49/10; H02K 7/10

(52) U.S. Cl. CPC H02K 49/102; H02K 7/10; H02K 2213/03

(57) ABSTRACT

A magnetic gear device includes: a magnetic gear including an inner magnet tube, an outer magnet tube, and arranged pole pieces provided between the inner and outer magnet tubes, such that one of them is used as a first rotor connected to an input portion, another one is used as a second rotor connected to an output portion, and the remaining one is used as a stator; and a rotary electric machine including a rotor having permanent magnets and a stator having teeth. A first value based on a L.C.M. of a number of the pole pieces and a number of poles of the first or second rotors coincides with a L.C.M. of a number of poles of the rotor and a number of the teeth, and/or a value obtained by multiplying the number of poles of the rotor by a multiple of 3.

### TECHNICAL FIELD

The present disclosure relates to a magnetic gear device.

### BACKGROUND ART

In recent years, a magnetic gear has been used in combination with a rotary electric machine in order to obtain desired output and efficiency characteristics from the rotary electric machine.

In a conventional magnetic gear composing a magnetic gear device, a cylindrical inner magnet tube having a plurality of magnets arranged side by side at an outer circumference, a cylindrical outer magnet tube having a plurality of magnets arranged side by side at an inner circumference, and a cylindrical magnetic material tube having a plurality of magnetic members arranged side by side with equal intervals therebetween in the circumferential direction, are coaxially supported with the magnetic material tube interposed between the inner magnet tube and the outer magnet tube, any two of the inner magnet tube, the outer magnet tube, and the magnetic material tube are used as rotors, and the remaining one is used as a stator, to transmit rotation torque. Each magnetic member has a bar shape extending in parallel to the axial-length direction of the magnetic material tube, and the magnets of the inner magnet tube and the outer magnet tube have positional displacements toward the same sides in the circumferential direction between one end and another end in the axial-length direction, thus being arranged in a skewed manner.

Thus, while a high torque density is ensured, cogging torque is effectively reduced, whereby motive power can be stably transmitted with reduced torque variation.

### CITATION LIST

### Patent Document

Patent Document 1: Japanese Patent No. 6213573

### SUMMARY OF THE INVENTION

### Problem to be Solved by the Invention

In a conventional magnetic gear described in Patent Document 1, permanent magnets need to be sequentially skewed in the axial direction, and therefore manufacturing is not easy. In addition, while torque pulsation can be reduced with a magnetic gear alone, speed fluctuation due to torque pulsation of a rotary electric machine occurs also on the output side of the magnetic gear.

The present disclosure has been made to solve the above problem, and an object of the present disclosure is to provide a magnetic gear device that can suppress speed fluctuation on the output side by reducing torque pulsation outputted from a combination of a magnetic gear and a rotary electric machine. Another object of the present disclosure is to manufacture the magnetic gear device easily and at low cost.

### Means to Solve the Problem

A magnetic gear device according to the present disclosure includes: a magnetic gear including an inner magnet tube having a plurality of first permanent magnets arranged at an outer circumference to form a fewer-pole mechanism, an outer magnet tube having a plurality of second permanent magnets arranged at an inner circumference to form a more-pole mechanism, and a magnetic material tube provided between the inner magnet tube and the outer magnet tube with magnetic gaps interposed from both of the inner magnet tube and the outer magnet tube, the magnetic material tube having N pole pieces made of a soft magnetic material and arranged with equal intervals therebetween in a circumferential direction, such that one of the inner magnet tube, the outer magnet tube, and the magnetic material tube is used as a first rotor connected to an input portion, another one is used as a second rotor connected to an output portion, and a remaining one is used as a stator; and a rotary electric machine including a rotor having M1 permanent magnets and a stator having M2 teeth. The magnetic gear is configured such that the input portion is connected to a rotary shaft of the rotary electric machine and an inputted rotational force is transmitted to the output portion. At least one of a first condition that a first value based on a least common multiple of the number N of the pole pieces and a number of poles of one of the first and second rotors coincides with a least common multiple M of M1 and M2, and a second condition that the first value coincides with a value obtained by multiplying M1 by a multiple of 3, is satisfied.

### Effect of the Invention

With the magnetic gear device according to the present disclosure, torque pulsation outputted from a combination of the magnetic gear and the rotary electric machine can be reduced, whereby speed fluctuation on the output side can be suppressed. In addition, the magnetic gear device can be manufactured easily and at low cost.

### BRIEF DESCRIPTION OF THE DRAWINGS

FIG. 1 is a vertical sectional view showing the configuration of a magnetic gear device according to embodiment 1.

FIG. 2 is a transverse sectional view showing the configuration of a rotary electric machine in the magnetic gear device according to embodiment 1.

FIG. 3 is a transverse sectional view showing the configuration of a magnetic gear in the magnetic gear device according to embodiment 1.

FIG. 4 is a partial transverse sectional view showing a positional relationship of parts of the magnetic gear according to embodiment 1.

FIG. 5 is a waveform diagram showing magnetic gear torque of the magnetic gear device according to embodiment 1.

FIG. 6 is a partial transverse sectional view showing a positional relationship of parts of the rotary electric machine according to embodiment 1.

FIG. 7 is a waveform diagram showing rotary electric machine torque in the magnetic gear device according to embodiment 1, in a case where current is not applied.

FIG. 8 is a waveform diagram showing rotary electric machine torque, magnetic gear torque, and combined torque in the magnetic gear device according to embodiment 1, in a case where current is not applied.

FIG. 9 is a waveform diagram showing change in torque pulsation of combined torque with respect to a phase shift of a rotor of the rotary electric machine, in the magnetic gear device according to embodiment 1.

FIG. 10 shows amplitudes in a frequency analysis result of magnetic gear torque in the magnetic gear device according to embodiment 1.

FIG. 11 shows amplitudes in a frequency analysis result of rotary electric machine torque in the magnetic gear device according to embodiment 1.

FIG. 12 is a waveform diagram showing a sixth-order component of torque in a generalized manner in the magnetic gear device according to embodiment 1.

FIG. 13 is a waveform diagram showing a twelfth-order component of torque in a generalized manner in the magnetic gear device according to embodiment 1.

FIG. 14 is a waveform diagram showing torque pulsations of a sixth-order component and a twelfth-order component of combined torque in a generalized manner in the magnetic gear device according to embodiment 1.

FIG. 15 is a vertical sectional view showing the configuration of a magnetic gear device according to another example of embodiment 1.

FIG. 16 is a waveform diagram showing rotary electric machine torque, magnetic gear torque, and combined torque in a magnetic gear device according to embodiment 2, when current is applied.

FIG. 17 is a vertical sectional view showing the configuration of a magnetic gear device according to embodiment 3.

FIG. 18 is a vertical sectional view showing the configuration of a magnetic gear device according to embodiment 4.

FIG. 19 is a vertical sectional view showing the configuration of a magnetic gear device according to embodiment 4.

### DESCRIPTION OF EMBODIMENTS

### Embodiment 1

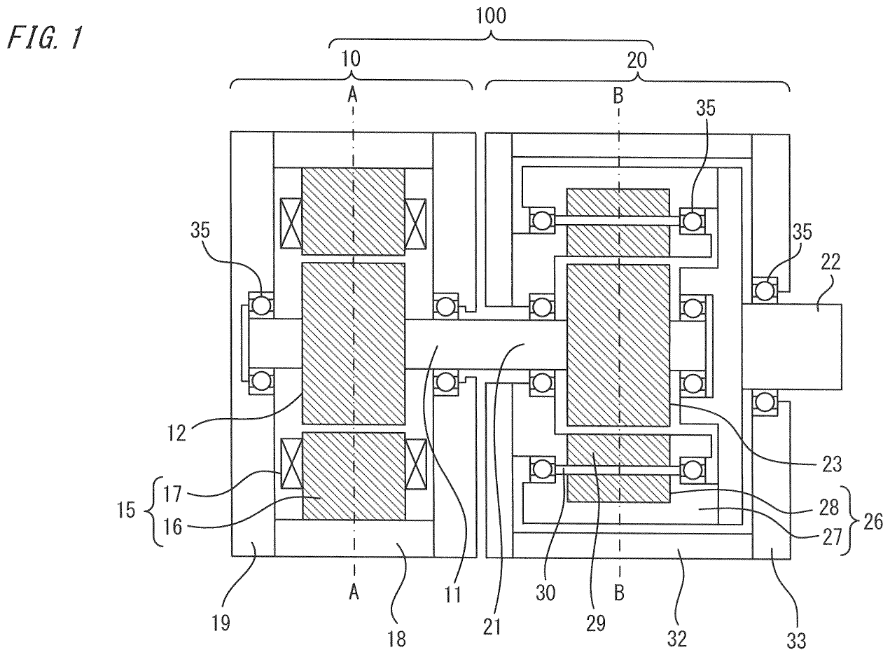

FIG. 1 is a vertical sectional view showing the configuration of a magnetic gear device according to embodiment 1. As shown in FIG. 1, a magnetic gear device 100 is formed as a driving unit including a rotary electric machine 10 and a magnetic gear 20.

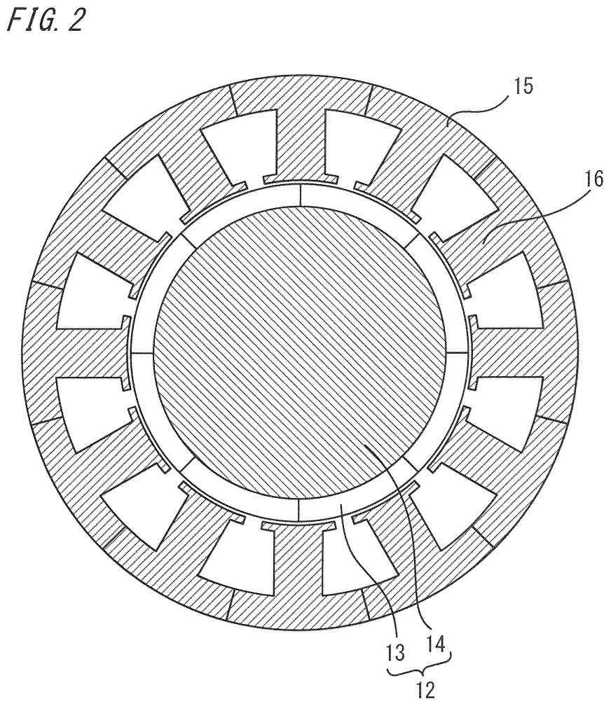

FIG. 2 is a transverse sectional view showing the configuration of the rotary electric machine 10 in the magnetic gear device 100, and shows a cross-section along line A-A in FIG. 1.

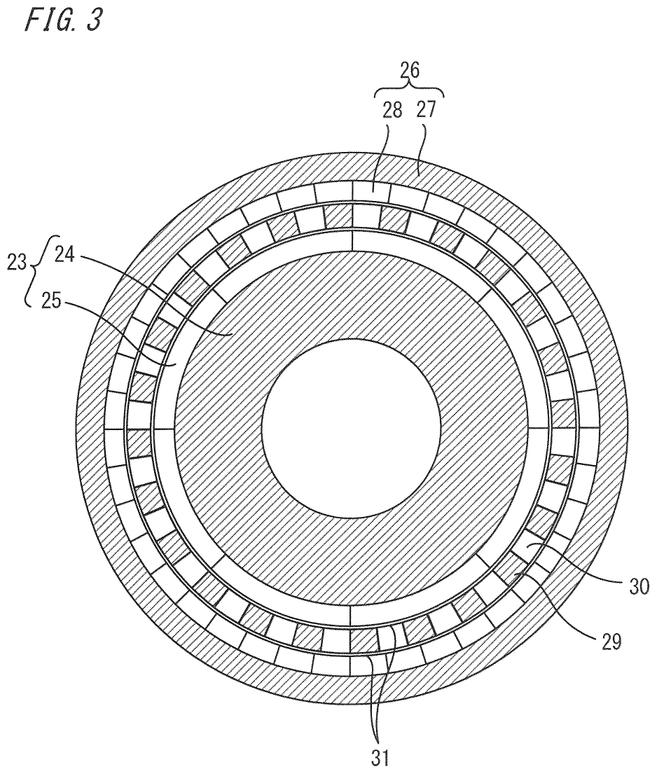

FIG. 3 is a transverse sectional view showing the configuration of the magnetic gear 20 in the magnetic gear device 100, and shows a cross-section along line B-B in FIG. 1.

As shown in the drawings, a shaft which is a rotary shaft 11 of the rotary electric machine 10 is connected to an input portion 21 of the magnetic gear 20, and the magnetic gear 20 transmits a rotational force inputted to the input portion 21, to an output portion 22. In this case, the input portion 21 of the magnetic gear 20 is formed integrally with the rotary shaft 11 of the rotary electric machine 10. The rotary electric machine 10 includes a rotor 12, and a stator 15 provided around the outer circumference of the rotor 12 with a magnetic gap interposed therebetween.

The rotor 12 is formed such that a plurality of (M1), in this case, eight permanent magnets 13 serving as magnetic poles are arranged side by side in the circumferential direction on an outer circumferential surface of a rotor core 14. The permanent magnets 13 are magnetized in the radial direction and are arranged such that the polarities of the permanent magnets 13 adjacent to each other are opposite to each other.

The stator 15 has a plurality of (M2), in this case, twelve teeth 16 protruding toward the magnetic gap, and a coil 17 is wound around each tooth 16. Thus, the rotary electric machine 10 has a concentrated winding structure with eight poles and twelve slots in which eight permanent magnets 13 and twelve teeth 16 are provided, as an example. For convenience sake, the coils 17 are not shown in FIG. 2.

The magnetic gear 20 includes an inner magnet tube 23 forming a fewer-pole mechanism having a smaller number of magnetic poles, an outer magnet tube 26 forming a more-pole mechanism having a larger number of magnetic poles, and a magnetic material tube 30 provided between the inner magnet tube 23 and the outer magnet tube 26 with magnetic gaps 31 interposed from both of the inner magnet tube 23 and the outer magnet tube 26.

The inner magnet tube 23 is formed such that a plurality of, in this case, eight first permanent magnets 25 serving as magnetic poles are arranged side by side in the circumferential direction on an outer circumferential surface of a cylindrical support body 24. The first permanent magnets 25 are magnetized in the radial direction and are arranged such that the polarities of the first permanent magnets 25 adjacent to each other are opposite to each other. The outer magnet tube 26 is formed such that a plurality of, in this case, forty second permanent magnets 28 serving as magnetic poles are arranged side by side in the circumferential direction on an inner circumferential surface of a cylindrical support body 27. The second permanent magnets 28 are magnetized in the radial direction and are arranged such that the polarities of the second permanent magnets 28 adjacent to each other are opposite to each other.

The magnetic material tube 30 provided between the inner magnet tube 23 and the outer magnet tube 26 is formed such that N, in this case, twenty-four pole pieces 29 formed of soft magnetic materials are arranged with equal intervals therebetween in the circumferential direction.

Parts where a driving force and a gear action occur (hatched parts in FIG. 1) in the rotary electric machine 10 and the magnetic gear 20 are made of a magnetic material. These parts are protected by frames (a rotary electric machine frame 18 and a magnetic gear frame 32) and brackets (a rotary electric machine bracket 19 and a magnetic gear bracket 33) formed by structure members made of iron, a nonmagnetic material, or the like.

In the magnetic gear 20, the inner magnet tube 23, the outer magnet tube 26, and the magnetic material tube 30 are arranged concentrically, one of the three tubes is used as a first rotor connected to the input portion 21, another one is used as a second rotor connected to the output portion 22, and the remaining one is used as a stator. Not only the first and second permanent magnets 25 and 28 of the magnetic gear 20 but also the N pole pieces 29 made of a soft magnetic material are referred to as magnetic poles of the rotor or the stator.

In the present embodiment, the inner magnet tube 23 is used as the first rotor, the outer magnet tube 26 is used as the second rotor, and the magnetic material tube 30 is used as the stator. The rotor 12 of the rotary electric machine 10, and the first rotor (inner magnet tube 23) and the second rotor (outer magnet tube 26) of the magnetic gear 20, are supported by a plurality of bearings 35.

That is, in the present embodiment, the rotor 12 of [0015] the rotary electric machine 10 and the first rotor (inner magnet tube 23) of the magnetic gear 20 are provided coaxially, and the first rotor (inner magnet tube 23) of the magnetic gear 20 rotates together with the rotary shaft 11 of the rotary electric machine 10. The first permanent magnets 25 of the first rotor (inner magnet tube 23) rotate while sequentially passing by the pole pieces 29 of the magnetic material tube 30 which is the stator, so that a magnetomotive force is provided to the second permanent magnets 28 of the second rotor (outer magnet tube 26). Then, the second rotor (outer magnet tube 26) rotates in a direction opposite to the first rotor (inner magnet tube 23).

In the magnetic gear device 100 configured as described above, a driving force produced by the rotary electric machine 10 undergoes speed reduction and torque increase or speed increase and torque reduction through the magnetic gear 20 and then the resultant force is outputted from the output portion 22 corresponding to an output shaft of the magnetic gear 20. In the present embodiment, a configuration to perform speed reduction and torque increase is shown.

The number of the first permanent magnets 25 of the first rotor (inner magnet tube 23) is eight, the number of the second permanent magnets 28 of the second rotor (outer magnet tube 26) is forty, and the number of the pole pieces 29 is twenty-four. Therefore, the gear ratio of the magnetic gear 20 is (40/2)/(8/2)=5. That is, through the magnetic gear 20, a rotational force inputted to the input portion 21 undergoes 1/5-fold speed reduction and 5-fold torque increase, and the resultant force is outputted to the output portion 22.

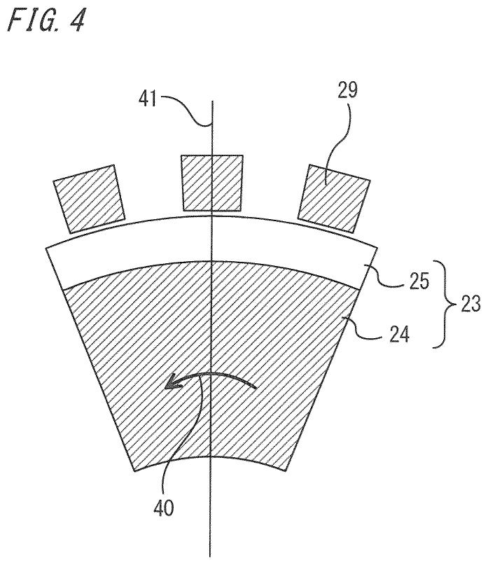

FIG. 4 is a partial transverse sectional view showing a positional relationship of parts of the magnetic gear 20. In FIG. 4, one of the first permanent magnets 25 of the first rotor (inner magnet tube 23) is shown together with the pole pieces 29 of the magnetic material tube 30. That is, a circumferential-direction range of 45° (=(360°/8)) in mechanically-defined angle (hereinafter, referred to as mechanical angle) is shown.

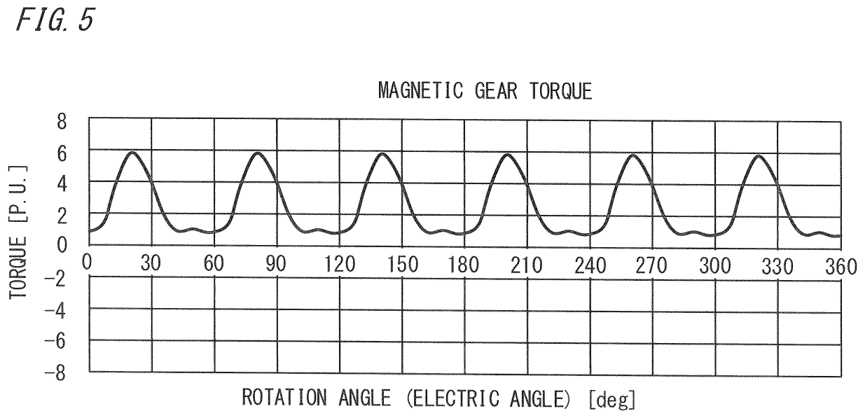

FIG. 5 is a waveform diagram showing magnetic gear torque of the magnetic gear device 100. In FIG. 5, a torque waveform of the first rotor (inner magnet tube 23) when the first rotor (inner magnet tube 23) is rotated by 360° in electrically-defined angle (hereinafter, referred to as electric angle), i.e., 90° (=(360°/(8/2))) in mechanical angle, is shown.

As shown in FIG. 5, it is found that, in magnetic gear torque, torque pulsation occurs six times while the first rotor (inner magnet tube 23) rotates by an electric angle of 360°. The torque pulsation occurs when the pole pieces 29 made of a magnetic material are similarly arranged at regular intervals at positions opposed to the first permanent magnets 25 arranged at regular intervals, and is also called cogging torque. The number of times of torque pulsation is determined by the relationship between the numbers of the first permanent magnets 25 and the pole pieces 29. As a general theory, it is known that, in a case where the first rotor (inner magnet tube 23) having the first permanent magnets 25 rotates by 360° in mechanical angle, the number of times of torque pulsation is a multiple of a least common multiple LCM of the number of the first permanent magnets 25 and the number of the pole pieces 29.

In this case, LCM (8, 24) is 24, and magnetic gear torque contains a component that oscillates 24K (K is a natural number) times in a mechanical angle range of 360°. Thus, magnetic gear torque oscillates 6K (=(24K/(8/2)) times in an electric angle range of 360°, and a component that oscillates six times at K=1 is contained in a large amount, which matches the result shown in FIG. 5.

In FIG. 5, the phase of the torque waveform is shown such that an angle when there is a cross-section in which a circumferential-direction magnetic-pole-center position of the first rotor (inner magnet tube 23) rotating in the direction of an arrow 40 coincides with a circumferential-direction center position of the pole piece 29 as shown by a center line 41 in FIG. 4 is defined as an initial angle of 0°.

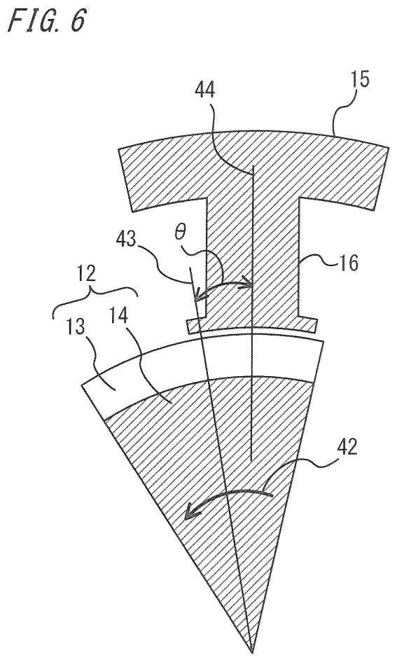

FIG. 6 is a partial transverse sectional view showing a positional relationship of parts of the rotary electric machine 10. In FIG. 6, in a circumferential-direction range (mechanical angle range of) 45° of one of the permanent magnets 13 of the rotor 12 of the rotary electric machine 10, the rotor core 14, the permanent magnet 13, and one of the teeth 16 of the stator 15 are shown.

In FIG. 6, a state in which a circumferential-direction magnetic-pole-center position (center line 43) of the rotor 12 rotating in the direction of an arrow 42 coincides with a circumferential-direction center position (center line 44) of the tooth 16 is used as a reference, and a phase shift of the circumferential-direction magnetic-pole-center position (center line 43) of the rotor 12 from the circumferential-direction center position (center line 44) of the tooth 16 is denoted by 0.

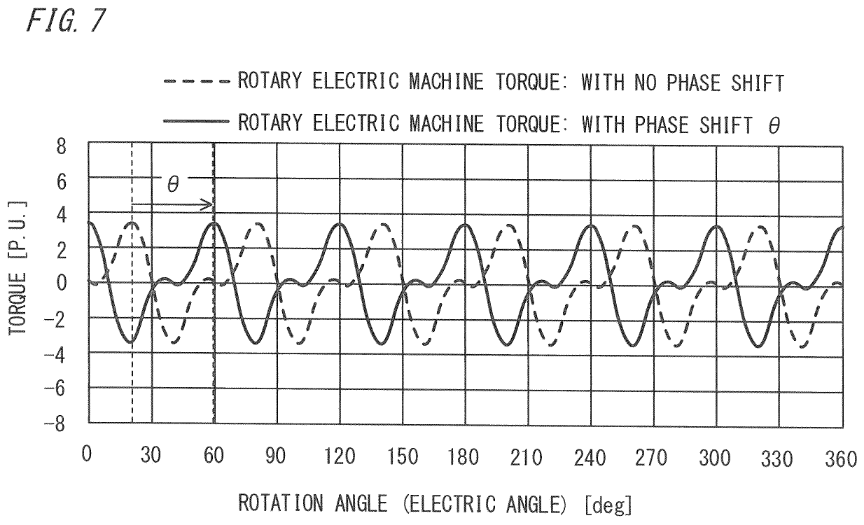

FIG. 7 is a waveform diagram showing rotary electric machine torque in a case where current is not applied. In FIG. 7, a torque waveform of the rotor 12 when the rotor 12 is rotated by an electric angle of 360°, i.e., a mechanical angle of 90° (=(360°/(8/2)), in a state in which current is not applied to the coil 17 of the rotary electric machine 10, is shown.

Here, a torque waveform with no phase shift is indicated by a dotted line, and a torque waveform with a phase shift θ is indicated by a solid line. For the torque waveform with no phase shift, an angle when there is a cross-section in which the circumferential-direction magnetic-pole-center position of the rotor 12 coincides with the circumferential-direction center position of the tooth 16 is defined as an initial angle of 0°. For the torque waveform with the phase shift θ, an angle when there is a cross-section in which the circumferential-direction magnetic-pole-center position of the rotor 12 is shifted from the circumferential-direction center position of the tooth 16 by the phase 0 is defined as an initial angle of 0°.

As shown in FIG. 7, rotary electric machine torque has torque pulsation containing a main component that oscillates six times, as in the magnetic gear torque described above.

Also, a principle for determining the number of times (order) of oscillation of the rotary electric machine 10 is the same as in the case of the magnetic gear 20 except that the pole pieces 29 arranged at regular intervals correspond to the teeth 16. That is, the number of times of torque pulsation in a case where the rotor 12 rotates by 360° in mechanical angle is a multiple of a least common multiple M of the number of poles of the rotor 12 which is the number of the permanent magnets 13 and the number of the teeth 16.

In this case, the least common multiple M (8, 12) is 24, and rotary electric machine torque contains a component that oscillates 24K (K is a natural number) times in a mechanical angle range of 360°. Thus, rotary electric machine torque oscillates 6K (=(24K/(8/2)) times in an electric angle range of 360°, and a component that oscillates six times at K=1 is contained in a large amount, which matches the result shown in FIG. 7.

In the magnetic gear device 100, the rotor 12 of the rotary electric machine 10 and the first rotor (inner magnet tube 23) of the magnetic gear 20 are connected, and combined torque of rotary electric machine torque and magnetic gear torque is the entire torque.

In the present embodiment, the least common multiple LCM of the number of the first permanent magnets 25 of the first rotor (inner magnet tube 23) of the magnetic gear 20 and the number of the pole pieces 29 coincides with the least common multiple M of the number of poles of the rotor 12 and the number of the teeth 16 of the rotary electric machine 10. That is, the main order component of torque pulsation per one revolution (rotation by a mechanical angle of) 360° of the first rotor (inner magnet tube 23) of the magnetic gear 20 and the main order component of torque pulsation per one revolution (rotation by a mechanical angle of) 360° of the rotor 12 of the rotary electric machine 10, are both twenty-four and coincide with each other.

Thus, torque pulsation of rotary electric machine torque and torque pulsation of magnetic gear torque are canceled out so as to be reduced.

The torque pulsations are changed with a relative relationship of two positional relationships shown below. The first one is a positional relationship between the pole pieces 29 of the magnetic gear 20 and the teeth 16 of the rotary electric machine 10. The second one is a positional relationship between the permanent magnets 13 of the rotor 12 of the rotary electric machine 10 and the first permanent magnets 25 of the first rotor (inner magnet tube 23) of the magnetic gear 20 connected through the shaft (rotary shaft 11) with the rotor 12 of the rotary electric machine 10.

That is, the phase e by which the circumferential-direction magnetic pole center of the rotor 12 is shifted from the circumferential-direction center position of the tooth 16 when the circumferential-direction magnetic pole center of the first rotor (inner magnet tube 23) coincides with the circumferential-direction magnetic pole center of the stator (magnetic material tube 30), i.e., the circumferential-direction center position of the pole piece 29, is used as a parameter which is a set angle, whereby it becomes possible to prescribe the above relative relationship that relates to the phase of torque pulsation.

The state shown in FIG. 4 corresponds to when the circumferential-direction magnetic pole center of the first rotor (inner magnet tube 23) coincides with the circumferential-direction center position of the pole piece 29. Then, in this state, the phase shift θ of the circumferential-direction magnetic-pole-center position (center line 43) of the rotor 12 from the circumferential-direction center position (center line 44) of the tooth 16 is adjusted (see FIG. 6). Thus, torque pulsation is effectively reduced, whereby speed fluctuation due to torque pulsation can be suppressed.

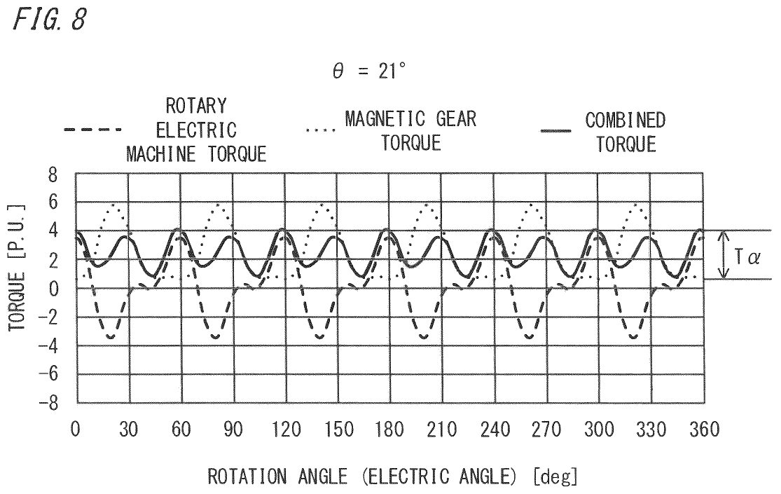

FIG. 8 is a waveform diagram showing rotary electric machine torque, magnetic gear torque, and combined torque in the magnetic gear device 100, in a case where current is not applied. In this case, a torque waveform (broken line) of the rotary electric machine 10, a torque waveform (dotted line) of the magnetic gear 20, and a combined torque waveform (solid line) obtained by adding both waveforms, with the phase shift θ set at 21°, are shown.

As shown in FIG. 8, a magnitude Ta of torque pulsation of the combined torque waveform, i.e., a difference (P-P) between the maximum value and the minimum value of the waveform, becomes significantly smaller than those of the torque waveform of the rotary electric machine 10 and the torque waveform of the magnetic gear 20, and thus torque pulsation is significantly reduced.

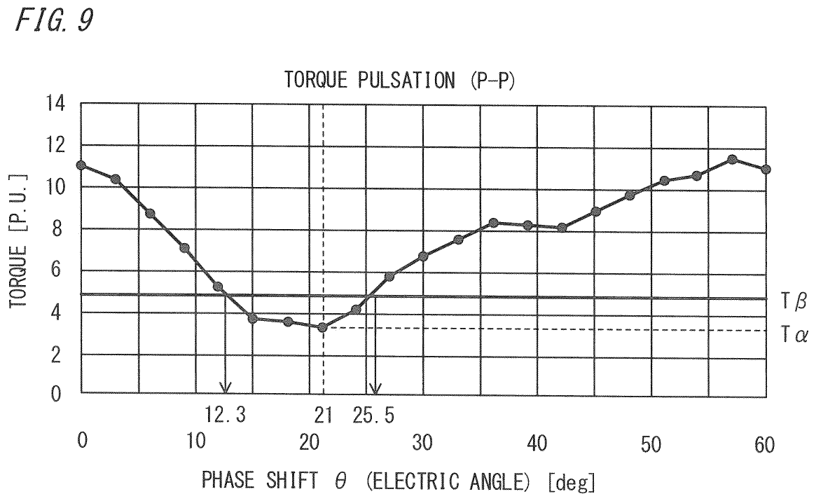

FIG. 9 is a waveform diagram showing change in torque pulsation of combined torque with respect to the phase shift θ of the rotor 12 of the rotary electric machine 10, in the magnetic gear device 100. Here, the phase shift θ is changed in a range of one cycle of a component that oscillates six times per electric angle of 360°, which is a main component of torque pulsation in rotary electric machine torque and magnetic gear torque, i.e., in an electric angle range of 60° (=(360/6)). Then, change in the magnitude (P-P) of torque pulsation with respect to the phase shift θ is shown.

The smaller one of the magnitude of torque pulsation of rotary electric machine torque and the magnitude of torque pulsation of magnetic gear torque is denoted by TB. With reference to FIG. 6 and FIG. 7, in this case, TB is the magnitude of torque pulsation of magnetic gear torque and is about 5.0.

As shown in FIG. 9, with θ defined as electric angle, torque pulsation of combined torque has a minimum value Tα around θ=21° and becomes smaller than torque pulsations of magnetic gear torque and rotary electric machine torque in a range of θ (12.3°<θ<) 25.5°.

The range of the phase shift θ in which the effect of reducing torque pulsation is obtained changes depending on features such as shapes and arrangements of permanent magnets and magnetic members (pole pieces, teeth, etc.) of the rotor. Therefore, the range of θ in which the reduction effect is generally expected is discussed below.

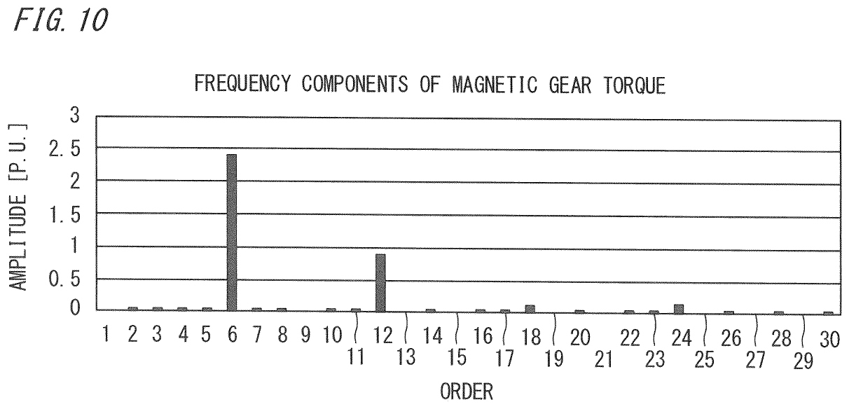

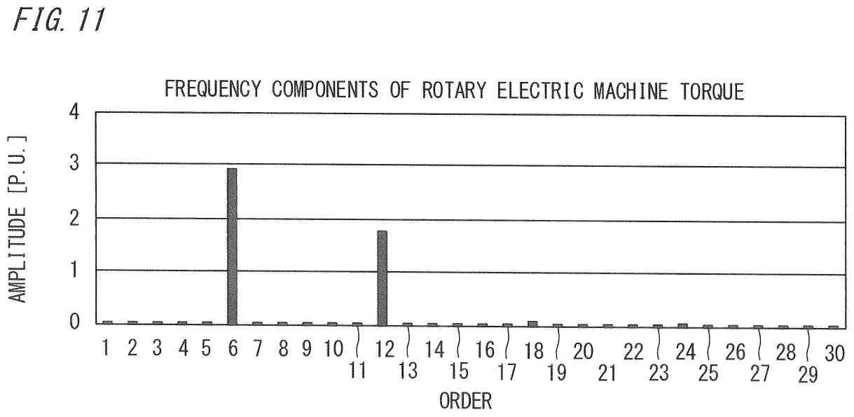

FIG. 10 shows amplitudes in a frequency analysis result of magnetic gear torque in the magnetic gear device 100. FIG. 11 shows amplitudes in a frequency analysis result of rotary electric machine torque in the magnetic gear device 100.

As described above, main components of torque pulsations of magnetic gear torque and rotary electric machine torque include components of multiples of the least common multiples of the numbers of the permanent magnets (25 and 13) and the magnetic members (teeth 16 and pole pieces 29), and in particular, 1-fold and 2-fold components are dominant. In the present embodiment, orders of torque pulsation in an electric angle range of 360° are represented as 6K, and therefore it is found that a sixth-order component (K=1) and a twelfth-order component (K=2) are dominant. In addition, it is generally known that these 1-fold (K=1) and 2-fold (K=2) order components are dominant in many structures, and therefore reduction in these two components is focused on. The magnitude relationship between the two components differs depending on the structures of the rotary electric machine 10 and the magnetic gear 20.

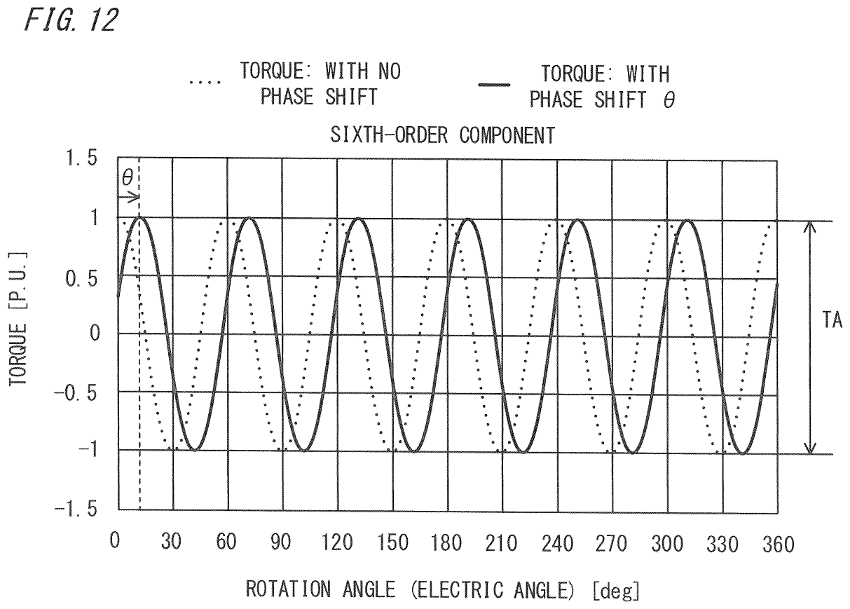

FIG. 12 is a waveform diagram showing a sixth-order component of torque in a generalized manner in the magnetic gear device 100. Here, in magnetic gear torque and rotary electric machine torque, only a sixth-order component is extracted and a torque waveform thereof generalized with its amplitude defined as 1 is shown in an electric angle range of 360°. In this case, a magnitude TA of torque pulsation is 2.0.

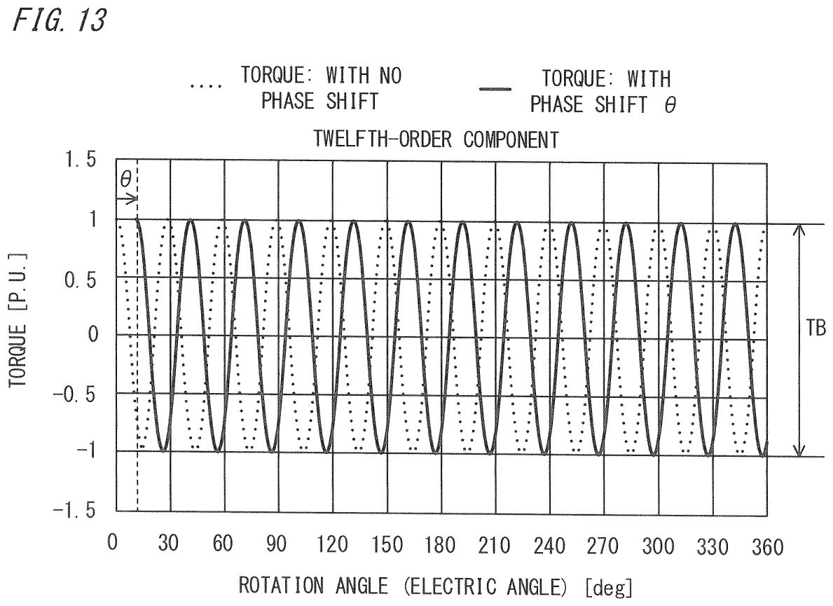

FIG. 13 is a waveform diagram showing a twelfth-order component of torque in a generalized manner in the magnetic gear device 100. Here, in magnetic gear torque and rotary electric machine torque, only a twelfth-order component is extracted and a torque waveform thereof generalized with its amplitude defined as 1 is shown in an electric angle range of 360°. In this case, a magnitude TB of torque pulsation is 2.0.

In FIG. 12 and FIG. 13, a torque waveform whose maximum value is at an initial angle is indicated by a dotted line, and a torque waveform with a phase shifted by the phase shift θ is indicated by a solid line.

As described above, in the present embodiment, in obtaining combined torque by adding rotary electric machine torque and magnetic gear torque, the phase shift θ of the circumferential-direction magnetic-pole-center position of the rotor 12 from the circumferential-direction center position of the tooth 16 is adjusted, whereby torque pulsation can be effectively reduced.

In FIG. 12 and FIG. 13, the torque waveform with no phase shift (dotted line) is assumed as magnetic gear torque, the torque waveform with the phase shift θ (solid line) is assumed as rotary electric machine torque, and both waveforms are added, whereby torque waveforms of a sixth-order component and a twelfth-order component of combined torque can be generated.

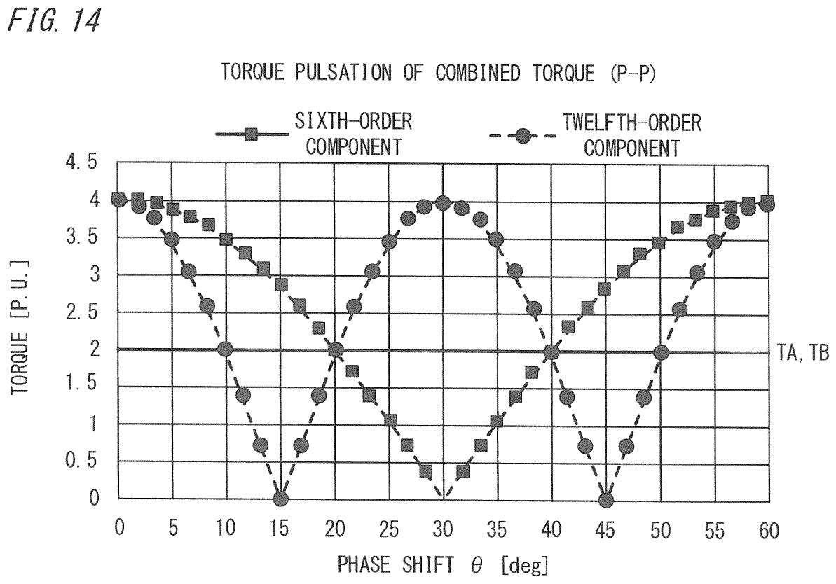

FIG. 14 is a waveform diagram showing torque pulsations of a sixth-order component and a twelfth-order component of combined torque in a generalized manner in the magnetic gear device 100.

In FIG. 14, change in torque pulsation with respect to the phase shift θ is shown for each of the sixth-order component combined torque and the twelfth-order component combined torque generated on the basis of FIG. 12 and FIG. 13. Also in this case, the phase shift θ is changed in a range of one cycle of a component that oscillates six times per electric angle of 360°, which is a main component of torque pulsation in rotary electric machine torque and magnetic gear torque, i.e., in an electric angle range of 60° (=(360/6)). Then, change in the magnitude (P-P) of torque pulsation with respect to the phase shift θ is shown.

With θ defined as electric angle, torque pulsation of sixth-order component combined torque becomes smaller than torque pulsations TA, TB (=2.0) of torques before combination, in a range of 20°<θ<40°. In addition, torque pulsation of twelfth-order component combined torque becomes smaller than torque pulsations TA, TB (=2.0) of torques before combination, in ranges of 10°<θ<20° and 40°<θ<50°.

That is, it is found that torque pulsation of sixth-order or twelfth-order component combined torque becomes smaller than torque pulsation of torque before combination, in a θ range of 10°<θ<50°.

The range of θ (12.3°<θ<) 25.5° shown in FIG. 9 is an example based on the configurations of the rotary electric machine 10 and the magnetic gear 20 of the magnetic gear device 100 according to the present embodiment, and is included in the above θ range (10°<θ<) 50°. Thus, it can be described that the reduction effect is exhibited owing to combination.

In the present embodiment, the least common multiple M of the number of poles of the rotor 12 and the number of the teeth 16 of the rotary electric machine 10 is set to be the order of torque pulsation, whereby components that oscillate M times and 2 M times per rotation of the rotor 12 by a mechanical angle of 360° can be reduced. Then, the above discussion based on electric angle is applied to mechanical angle, whereby a range of a phase shift φ (mechanical angle) in which torque pulsation can be reduced is obtained as (360/M/6) °<φ<((360/M/6)×5))°.

That is, torque pulsation is effectively reduced with such a positional relationship that the circumferential-direction magnetic pole center of the rotor 12 is shifted from the circumferential-direction center position of the tooth 16 by the phase (mechanical angle) φ in a range of (360/M/6) °<φ<((360/M/6)×5)) ° when the circumferential-direction magnetic pole center of the first rotor (inner magnet tube 23) coincides with the circumferential-direction center position of the fixed pole piece 29.

As described above, in the present embodiment, the least common multiple LCM of the number N of the pole pieces 29 and the number of poles of the first rotor (inner magnet tube 23) of the magnetic gear 20 coincides with the least common multiple M of the number of poles of the rotor 12 and the number of the teeth 16 of the rotary electric machine 10. Thus, the magnetic gear device 100 which is a combination of the magnetic gear 20 and the rotary electric machine 10 can reduce torque pulsation to be outputted, whereby speed fluctuation on the output side can be suppressed. In addition, special working is not needed for the first and second permanent magnets 25 and 27 to be used in the magnetic gear 20, and therefore the magnetic gear device 100 can be manufactured easily and at low cost.

In addition, when the circumferential-direction magnetic pole center of the first rotor (inner magnet tube 23) coincides with the circumferential-direction center position of the fixed pole piece 29, the circumferential-direction magnetic pole center of the rotor 12 is phase-shifted from the circumferential-direction center position of the tooth 16 by a set angle, so that torque pulsation of the rotary electric machine 10 and torque pulsation of the magnetic gear 20 are reduced with each other. Thus, torque pulsation of combined torque outputted from the magnetic gear device 100 is effectively reduced, whereby speed fluctuation on the output side is suppressed.

In addition, in the present embodiment, the number of poles of the first rotor (inner magnet tube 23) of the magnetic gear 20 coincides with the number of poles of the rotor 12 of the rotary electric machine 10. Thus, designing can be made so as to use same-specification products for the permanent magnets 13 of the rotor 12 of the rotary electric machine 10 and the first permanent magnets 25 of the first rotor (inner magnet tube 23) of the magnetic gear 20, whereby the manufacturing cost can be reduced.

In addition, in the magnetic gear device 100, normally, from the standpoints of output and efficiency, required specifications for the rotary electric machine 10 are determined first, and then the number of poles of the rotor 12 and the number of the teeth 16 are determined accordingly. Next, the magnetic gear 20 is selected so that torque pulsation of magnetic gear torque and torque pulsation of rotary electric machine torque can be reduced by being canceled out. That is, the main order of torque pulsation generated from the magnetic gear 20 is equal to or greater than the order of torque pulsation generated from the rotary electric machine 10.

In the magnetic gear 20, it is desirable that the number of poles of the first rotor (inner magnet tube 23) connected to the output shaft of the rotary electric machine 10 is equal to or greater than the number of poles of the rotor 12 of the rotary electric machine 10. As described above, among orders of torque pulsation of the magnetic gear 20, the least common multiple LCM of the number N of the pole pieces 29 and the number of poles of the first rotor (inner magnet tube 23) is dominant. Therefore, in a case where the number of poles of the first rotor (inner magnet tube 23) is smaller than the number of poles of the rotor 12 of the rotary electric machine 10, a component for an order smaller than orders of components of torque pulsation generated by the rotary electric machine 10 might increase, so that the effect of reducing torque pulsation cannot be obtained as a whole.

The present embodiment has shown the magnetic gear device 100 in which the eight-pole twelve-slot rotary electric machine 10 and the magnetic gear 20 including the eight-pole first rotor (inner magnet tube 23) forming a fewer-pole mechanism, the forty-pole second rotor (outer magnet tube 26) forming a more-pole mechanism, and twenty-four pole pieces 29 forming the magnetic material tube 30, are combined. To generalize this example, with X and Y defined as integers, the magnetic gear 20 in which the number of poles of the first rotor (inner magnet tube 23) is 2X, the number of poles of the second rotor (outer magnet tube 26) is 2Y, and the number of the pole pieces 29 is (X+Y), is discussed below.

In this magnetic gear 20, while the first rotor (inner magnet tube 23) rotates by 360° in electric angle, i.e., rotates by (360/X) ° in mechanical angle, magnetic gear torque oscillates the same number of times as (least common multiple LCM (2X, (X+Y))/X). Therefore, the number of times magnetic gear torque oscillates while the first rotor (inner magnet tube 23) makes one revolution is (LCM (2X, (X+Y))/X)×(360/(360/X))=LCM (2X, (X+Y)).

Thus, it is found that, if the least common multiple M of the number of poles of the rotor 12 and the number of the teeth 16 of the rotary electric machine 10 coincides with the least common multiple LCM of the number of poles of the first rotor (inner magnet tube 23) connected to the rotary shaft 11 of the rotary electric machine 10 and the number of the pole pieces 29, it becomes possible to perform such adjustment that can reduce torque pulsation of magnetic gear torque and torque pulsation of rotary electric machine torque by cancellation.

In the above embodiment, the rotary shaft 11 of the rotary electric machine 10 is formed integrally with the input portion 21 of the magnetic gear 20. However, the present invention is not limited thereto.

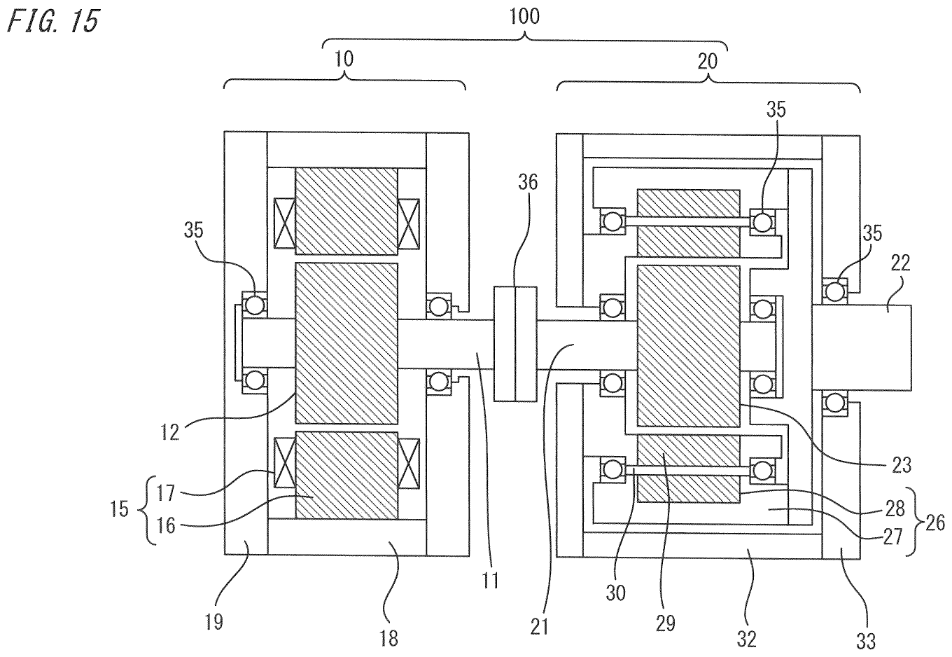

FIG. 15 is a vertical sectional view showing the configuration of the magnetic gear device 100 according to another example of embodiment 1.

As shown in FIG. 15, the rotary shaft 11 of the rotary electric machine 10 is connected to the input portion 21 of the magnetic gear 20 via a connection mechanism 36 for a rotational force, e.g., a shaft coupling. The connection mechanism 36 may be a belt, a mechanical gear, a magnetic coupling, or the like, instead of a shaft coupling.

Thus, also in a case where the rotary shaft 11 of the rotary electric machine 10 is connected to the input portion 21 of the magnetic gear 20 via the connection mechanism 36 for a rotational force, the same effects as in the above embodiment 1 are obtained.

In the above embodiment, the example in which the pole pieces 29 are fixed has been shown. However, the pole pieces 29 may be rotatable so that phase adjustment can be arbitrarily performed, whereby the same effects are obtained.

### Embodiment 2

In the above embodiment 1, reduction in torque pulsation in the magnetic gear device 100 in a case where current is not applied has been described. In the present embodiment 2, reduction in torque pulsation in the magnetic gear device 100 in a case where current is applied to the rotary electric machine 10 will be described. The structure of the magnetic gear device 100 in the present embodiment is the same as that shown in FIG. 1 to FIG. 3 in the above embodiment 1.

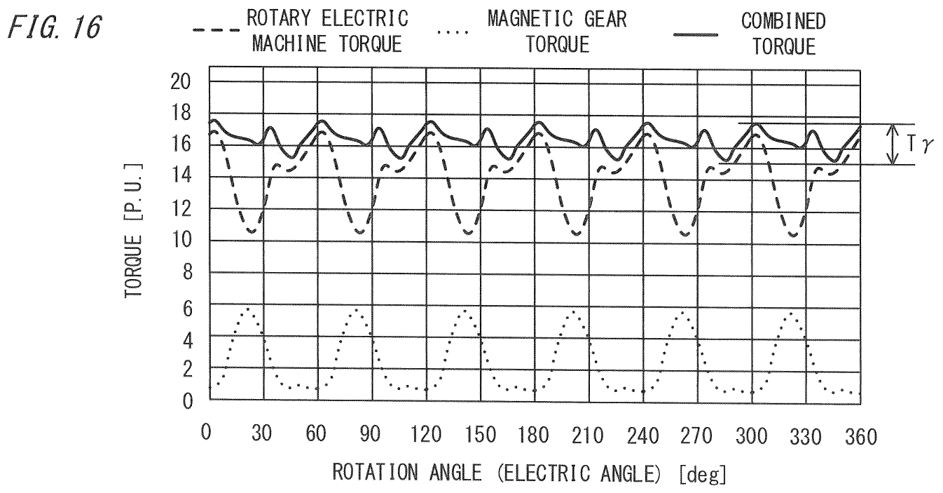

FIG. 16 is a waveform diagram showing rotary electric machine torque, magnetic gear torque, and combined torque in the magnetic gear device according to embodiment 2, when current is applied.

As described above, in the magnetic gear device 100, the rotor 12 of the rotary electric machine 10 and the first rotor (inner magnet tube 23) of the magnetic gear 20 are connected, and combined torque of rotary electric machine torque and magnetic gear torque is the entire torque. FIG. 16 shows a torque waveform (broken line) of the rotary electric machine 10, a torque waveform (dotted line) of the magnetic gear 20, and a combined torque waveform (solid line) obtained by adding both waveforms, in a case where current is being applied to the coils 17 of the rotary electric machine 10.

The waveform of magnetic gear torque is the same as the torque waveform shown in FIG. 5 in the above embodiment 1, i.e., torque pulsation occurs six times while the first rotor (inner magnet tube 23) rotates by an electric angle of 360°. As described above, since the least common multiple LCM of the number of poles of the first rotor (inner magnet tube 23) which is the number of the first permanent magnets 25 and the number of the pole pieces 29 is 24, magnetic gear torque oscillates 6K (=(24K/(8/2)) times in an electric angle range of 360°. Thus, a component that oscillates six times at K=1 is contained in a large amount.

As shown in FIG. 16, it is found that, in rotary electric machine torque, a sixth-order torque pulsation component that oscillates six times while the rotor 12 rotates by an electric angle of 360° is dominant. It is generally known that, in the rotary electric machine 10, when current is applied, a torque pulsation component that oscillates (6×N1) times (N1 is a natural number) during rotation by 360° in electric angle increases.

As shown in FIG. 16, a magnitude Ty of torque pulsation of the combined torque waveform, i.e., a difference (P-P) between the maximum value and the minimum value of the waveform, becomes significantly smaller than those of the torque waveform of the rotary electric machine 10 and the torque waveform of the magnetic gear 20, and thus torque pulsation is significantly reduced.

Also in the present embodiment 2, as in the above embodiment 1, if the main order of torque pulsation of the rotary electric machine 10 coincides with the main order of torque pulsation of the magnetic gear 20, the effect of reducing torque pulsation is obtained in combined torque through phase-related adjustment. That is, if the condition that the number of poles of the rotor 12 of the rotary electric machine 10×(3×N1) coincides with the least common multiple LCM of the number of poles of the first rotor (inner magnet tube 23) connected to the rotary shaft 11 of the rotary electric machine 10 and the number the pole pieces 29, is satisfied, the effect of reducing torque pulsation is obtained when current is applied to the rotary electric machine 10.

In this case, the least common multiple LCM (=24) is three times the number of poles (=8) of the rotor 12 of the rotary electric machine 10, and thus satisfies the above condition at N1=1, whereby the effect of reducing torque pulsation is obtained.

The phase of torque pulsation of the rotary electric machine 10 when current is applied changes depending on the states of the amplitude and the phase of current, and the sectional shape of the rotary electric machine 10. Accordingly, phase adjustment is performed by making such arrangement that torque pulsations are cancelled out in desired states of the amplitude and the phase of current where oscillation reduction is required. For example, a driving motor for a vehicle is often used in a low-to-middle torque region operation, and therefore a phase relationship is selected such that torque pulsations are canceled out in the condition in which the amplitude and the phase of current are in the above torque region.

Phase adjustment at this time can also be performed by adjusting the phase (phase shift θ) between the circumferential-direction magnetic pole center of the rotor 12 and the circumferential-direction center position of the tooth 16 when the circumferential-direction magnetic pole center of the first rotor (inner magnet tube 23) coincides with the circumferential-direction center position of the pole piece 29, as in the above embodiment 1. Then, by performing phase adjustment so that torque pulsation of the rotary electric machine 10 and torque pulsation of the magnetic gear 20 are reduced with each other, torque pulsation is effectively reduced, whereby speed fluctuation due to torque pulsation can be suppressed.

The condition that the least common multiple LCM of the number N of the pole pieces 29 and the number of poles of the first rotor (inner magnet tube 23) of the magnetic gear 20 coincides with the least common multiple M of the number of poles of the rotor 12 and the number of the teeth 16 of the rotary electric machine 10, as described in the above embodiment 1, is defined as a first condition. Then, the condition that the least common multiple LCM of the number N of the pole pieces 29 and the number of poles of the first rotor (inner magnet tube 23) of the magnetic gear 20 coincides with the number of poles of the rotor 12 of the rotary electric machine 10×(3×N1), as described in the present embodiment, is defined as a second condition. With the first condition and the second condition set as described above, if at least one of the first condition and the second condition is satisfied, the effect of reducing torque pulsation is obtained.

In the magnetic gear device 100 used in the present embodiment, the least common multiple LCM (=24) of the number N of the pole pieces 29 and the number of poles of the first rotor (inner magnet tube 23) of the magnetic gear 20 coincides with the least common multiple M (=24) of the number of poles of the rotor 12 and the number of the teeth 16 of the rotary electric machine 10, and coincides with three times the number of poles of the rotor 12. Therefore, both of the first condition and the second condition are satisfied. Thus, the magnetic gear device 100 can provide the effect of reducing torque pulsation in both of a case where current is not applied and a case where current is applied.

### Embodiment 3

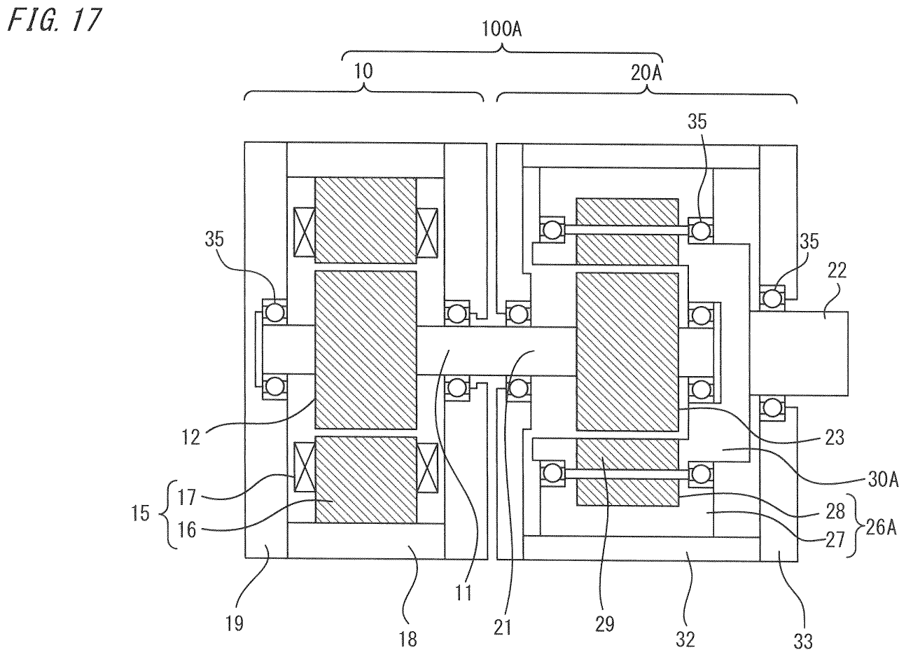

FIG. 17 is a vertical sectional view showing the configuration of a magnetic gear device according to embodiment 3.

As shown in FIG. 17, a magnetic gear device 100A is formed as a driving unit including the rotary electric machine 10 and a magnetic gear 20A.

The rotary electric machine 10 is the same as that in the above embodiment 1. The magnetic gear 20A includes the inner magnet tube 23 forming a fewer-pole mechanism having a smaller number of magnetic poles, an outer magnet tube 26A forming a more-pole mechanism having a larger number of magnetic poles, and a magnetic material tube 30A provided between the inner magnet tube 23 and the outer magnet tube 26A with magnetic gaps 31 interposed from both of the inner magnet tube 23 and the outer magnet tube 26A. The transverse sectional view thereof is the same as that in FIG. 3, but a combination of the number of the first permanent magnets 25 of the inner magnet tube 23, the number of the second permanent magnets 28 of the outer magnet tube 26A, and the number of the pole pieces 29 of the magnetic material tube 30A, is different.

In the magnetic gear 20A, the inner magnet tube 23, the outer magnet tube 26A, and the magnetic material tube 30A are arranged concentrically, one of the three tubes is used as a first rotor connected to the input portion 21, another one is used as a second rotor connected to the output portion 22, and the remaining one is used as a stator.

In the present embodiment, the inner magnet tube 23 is used as the first rotor, the magnetic material tube 30A is used as the second rotor, and the outer magnet tube 26A is used as the stator.

The other configurations are the same as in the above embodiment 1.

That is, in the present embodiment, the rotor 12 of the rotary electric machine 10 and the first rotor (inner magnet tube 23) of the magnetic gear 20A are provided coaxially, and the first rotor (inner magnet tube 23) of the magnetic gear 20A rotates together with the rotary shaft 11 of the rotary electric machine 10. Thus, a magnetomotive force is provided to the pole pieces 29 of the second rotor (magnetic material tube 30A) placed between the stator (outer magnet tube 26A) and the first rotor (inner magnet tube 23). Then, the second rotor (magnetic material tube 30A) rotates in the same direction as the first rotor (inner magnet tube 23).

Thus, in the magnetic gear device 100A, a driving force produced by the rotary electric machine 10 undergoes speed reduction and torque increase or speed increase and torque reduction through the magnetic gear 20A and then the resultant force is outputted from the output portion 22 corresponding to an output shaft of the magnetic gear 20A.

A combination of the number of the first permanent magnets 25 of the inner magnet tube 23, the number of the second permanent magnets 28 of the outer magnet tube 26A, and the number N of the pole pieces 29 of the magnetic material tube 30A in the magnetic gear 20A is shown below. With X and Y (>X) defined as natural numbers, the number of the first permanent magnets 25 of the inner magnet tube 23 is 2X, the number of the second permanent magnets 28 of the outer magnet tube 26A is 2Y, and the number N of the pole pieces 29 of the magnetic material tube 30A is (X+Y).

While the first rotor (inner magnet tube 23) rotates relative to the second rotor (magnetic material tube 30) by 360° in electric angle, i.e., (360/X+360/Y) ° in mechanical angle, magnetic gear torque oscillates the same number of times as a value obtained by dividing the least common multiple LCM of the number N of the pole pieces 29 and the number of poles of the first rotor (inner magnet tube 23) by X, i.e., (LCM (2X, (X+Y))/X) times. That is, the number of times magnetic gear torque oscillates while the first rotor (inner magnet tube 23) rotates by 360° in mechanical angle is (LCM (2X, (X+Y))/X)×(360/(360/X+360/Y))=LCM (2X, (X+Y))×(Y/(X+Y)).

Therefore, the magnetic gear 20A is configured by determining a combination of the number of the first permanent magnets 25 of the inner magnet tube 23, the number of the second permanent magnets 28 of the outer magnet tube 26A, and the number N of the pole pieces 29 of the magnetic material tube 30A so that the least common multiple M of the number of poles of the rotor 12 and the number of the teeth 16 of the rotary electric machine 10 coincides with LCM (2X, (X+Y))×(Y/(X+Y)).

That is, a value obtained by multiplying the least common multiple LCM of the number N of the pole pieces 29 and the number of poles of the first rotor (inner magnet tube 23) by ((the number of poles of the stator (outer magnet tube 26A))/N) is defined as a first value, and setting is made so as to satisfy the first condition that the first value coincides with the least common multiple M of the number of poles of the rotor 12 and the number of the teeth 16 of the rotary electric machine 10.

Thus, in a case where current is not applied in the rotary electric machine 10, if the main order of torque pulsation of the rotary electric machine 10 and the main order of torque pulsation of the magnetic gear 20A coincide with each other, these torque pulsations can be canceled out so as to be reduced, through phase-related adjustment, whereby torque pulsation in combined torque is reduced.

Also in this case, as in the above embodiment 1, the phase (phase shift θ) between the circumferential-direction magnetic pole center of the rotor 12 and the circumferential-direction center position of the tooth 16 when the circumferential-direction magnetic pole center of the first rotor (inner magnet tube 23) coincides with the circumferential-direction magnetic pole center of the stator (outer magnet tube 26A), is adjusted. Then, by performing phase adjustment so that torque pulsation of the rotary electric machine 10 and torque pulsation of the magnetic gear 20 are reduced with each other, torque pulsation is effectively reduced, whereby speed fluctuation due to torque pulsation can be suppressed.

Thus, the magnetic gear device 100A can reduce torque pulsation to be outputted, whereby speed fluctuation on the output side can be suppressed.

In addition, as in the above embodiment 1, special working is not needed for the first and second permanent magnets 25 and 28 to be used in the magnetic gear 20A, and therefore the magnetic gear device 100A can be manufactured easily and at low cost.

The configuration of the magnetic gear device 100A may be set so as to satisfy the second condition that the first value obtained by multiplying the least common multiple LCM of the number N of the pole pieces 29 and the number of poles of the first rotor (inner magnet tube 23) by ((the number of poles of the stator (outer magnet tube 26A))/N) coincides with the number of poles of the rotor 12 of the rotary electric machine 10×(3×N1). In this case, as shown in the above embodiment 2, the effect of reducing torque pulsation in a case where current is applied in the rotary electric machine 10 is obtained.

That is, if at least one of the first condition and the second condition is satisfied, the effect of reducing torque pulsation is obtained through phase-related adjustment. In addition, if both of the first condition and the second condition are satisfied, the magnetic gear device 100A can provide the effect of reducing torque pulsation in both of a case where current is not applied and a case where current is applied.

In addition, in the present embodiment, the structure in which the magnetic material tube 30A having the pole pieces 29 rotates as the first rotor is adopted, whereby the gear ratio can be improved as compared to the above embodiment 1. In addition, since the outer magnet tube 26A at the outermost circumferential part of the magnetic gear 20A is the stator, the structure can be simplified and the manufacturing cost can be reduced.

In addition, it is desirable that the magnetic gear 20A satisfies at least one of a condition that the number of poles of the first rotor (inner magnet tube 23) connected to the output shaft of the rotary electric machine 10 is equal to or greater than the number of poles of the rotor 12 of the rotary electric machine 10, and a condition that the number of the pole pieces 29 of the second rotor (magnetic material tube 30A) is equal to or greater than the number of the teeth 16 of the rotary electric machine 10. Thus, the magnetic gear 20A can be assuredly selected so that the main order of torque pulsation generated by the magnetic gear 20A becomes equal to or greater than the order of torque pulsation generated by the rotary electric machine 10, whereby torque pulsation of combined torque outputted from the magnetic gear device 100A can be suppressed.

In the above embodiment, the example in which the stator (outer magnet tube 26A) is fixed has been shown. However, the stator (outer magnet tube 26A) may be rotatable so that phase adjustment can be arbitrarily performed, whereby the same effects are obtained.

In the above embodiments, the example in which the rotary shaft 11 of the rotary electric machine 10 and the rotary shaft (input portion 21) of the magnetic gear 20, 20A are arranged coaxially has been shown, but the present disclosure is not limited thereto. The same effects are obtained as long as the rotary shaft 11 of the rotary electric machine 10 and the input portion 21 of the magnetic gear 20, 20A are connected.

### Embodiment 4

In the present embodiment 4, the rotor 12 of the rotary electric machine 10 and the first rotor (inner magnet tube 23) of the magnetic gear 20 in the magnetic gear device 100A of the above embodiment 3 are formed integrally.

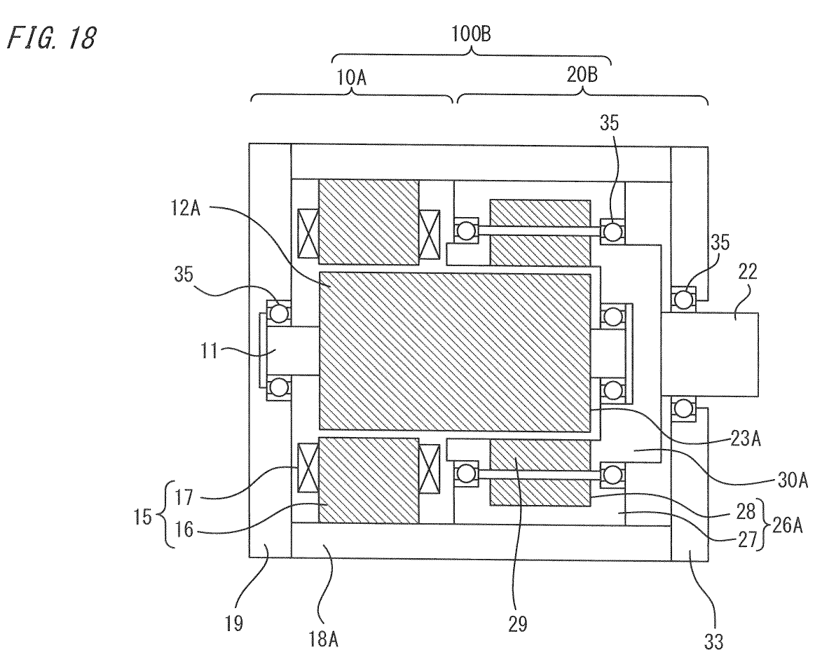

FIG. 18 is a vertical sectional view showing the configuration of a magnetic gear device according to embodiment 4.

As shown in FIG. 18, a magnetic gear device 100B is formed as a driving unit including a rotary electric machine 10A and a magnetic gear 20B. In this case, a rotor 12A of the rotary electric machine 10A is formed integrally with the first rotor (inner magnet tube 23A) of the magnetic gear 20B. The other configurations are the same as in the above embodiment 3.

In the present embodiment, a rotor core material is shared between the magnetic gear 20B and the rotary electric machine 10A, whereby structure members can be further decreased. Thus, the manufacturing cost can be further reduced.

Also in this case, if at least one of the first condition and the second condition shown in the above embodiment 3 is satisfied, as in the above embodiment 3, torque pulsation can be reduced through phase-related adjustment, whereby speed fluctuation on the output side can be suppressed. Where a value obtained by multiplying the least common multiple LCM of the number N of the pole pieces 29 and the number of poles of the first rotor (inner magnet tube 23A) by ((the number of poles of the stator (outer magnet tube 26A))/N) is defined as a first value, the first condition is a condition that the first value coincides with the least common multiple M of the number of poles of the rotor 12 and the number of teeth 16 of the rotary electric machine 10. The second condition is a condition that the first value coincides with the number of poles of the rotor 12 of the rotary electric machine 10×(3×N1).

In the above embodiment 4, the structure in which the rotary electric machine 10A and the magnetic gear 20B are stored in the same frame 18A has been shown. However, they may be stored in separate frames.

In the above embodiments 1 to 4, the example in which the magnetic gear 20, 20A, 20B is a speed-reduction gear that makes speed reduction and torque increase, has been shown. However, in a case where the outer magnet tube 26 which is a more-pole mechanism of the magnetic gear 20, 20A, 20B is used as the first rotor and is connected to the rotary shaft 11 of the rotary electric machine 10, 10A, a speed-increase gear that makes speed increase and torque reduction can be obtained. Also in this case, the same effects as in the above embodiments are obtained.

### Embodiment 5

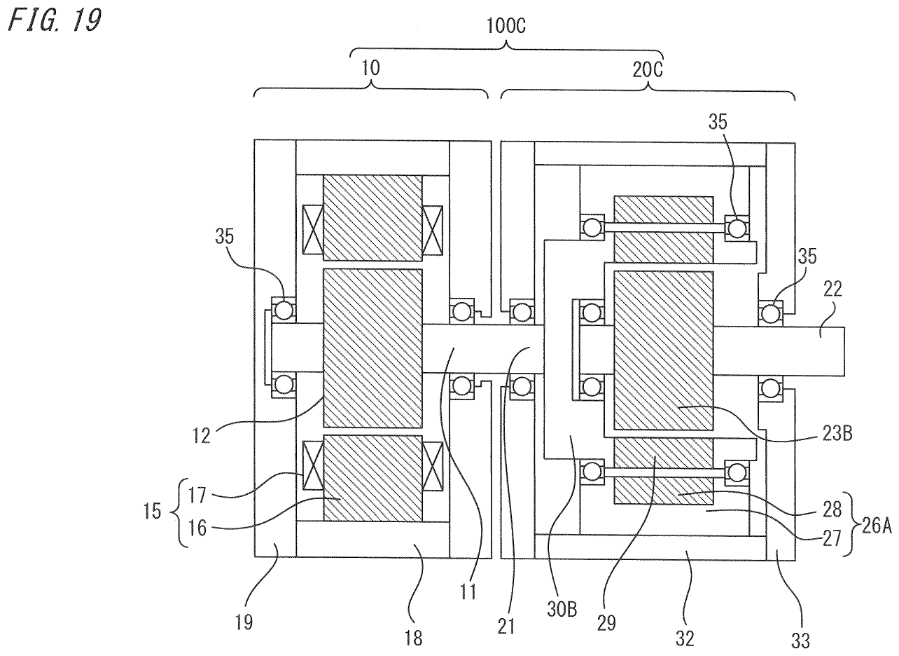

FIG. 19 is a vertical sectional view showing the configuration of a magnetic gear device according to embodiment 5.

As shown in FIG. 19, a magnetic gear device 100C is formed as a driving unit including the rotary electric machine 10 and a magnetic gear 20C.

In the present embodiment, in the magnetic gear 20C, an inner magnet tube 23B, the outer magnet tube 26A, and a magnetic material tube 30B are arranged coaxially, the magnetic material tube 30B is used as a first rotor, one of the inner magnet tube 23B and the outer magnet tube 26A is used as a second rotor, and the other is used as a stator. Here, a case where the inner magnet tube 23B is used as the second rotor and the outer magnet tube 26A is used as the stator is shown. The other configurations are the same as in the above embodiment 1.

In this case, a value obtained by multiplying the least common multiple of the number N of the pole pieces 29 and the number of poles of the second rotor (the inner magnet tube 23B or the outer magnet tube 26A) by ((the number of poles of the stator (the outer magnet tube 26A or the inner magnet tube 23B))/N) is defined as a first value. Then, setting is made so as to satisfy the first condition that the first value coincides with the least common multiple M of the number of poles of the rotor 12 and the number of the teeth 16 of the rotary electric machine 10.

Thus, in a case where current is not applied in the rotary electric machine 10, if the main order of torque pulsation of the rotary electric machine 10 and the main order of torque pulsation of the magnetic gear 20C coincide with each other, these torque pulsations can be canceled out so as to be reduced, through phase-related adjustment, whereby torque pulsation in combined torque is reduced.

Also in this case, as in the above embodiment 1, the phase (phase shift θ) between the circumferential-direction magnetic pole center of the rotor 12 and the circumferential-direction center position of the tooth 16 when the circumferential-direction magnetic pole center of the first rotor (magnetic material tube 30B), i.e., the circumferential-direction center position of the pole piece 29, coincides with the circumferential-direction magnetic pole center of the stator (the outer magnet tube 26A or the inner magnet tube 23B), is adjusted. Then, by performing phase adjustment so that torque pulsation of the rotary electric machine 10 and torque pulsation of the magnetic gear 20C are reduced with each other, torque pulsation is effectively reduced, whereby speed fluctuation due to torque pulsation can be suppressed.

Setting may be made so as to satisfy the second condition that the first value coincides with the number of poles of the rotor 12 of the rotary electric machine 10×(3×N1). In this case, as shown in the above embodiment 2, the effect of reducing torque pulsation in a case where current is applied in the rotary electric machine 10 is obtained. That is, if at least one of the first condition and the second condition is satisfied, the effect of reducing torque pulsation is obtained through phase-related adjustment.

In the above embodiments, the number of permanent magnets forming each magnetic pole of the rotary electric machine 10 and the magnetic gear 20, 20A, 20B, 20C is not limited to one. The same effects are obtained also in a case of dividing the permanent magnet in the magnetization direction, a direction perpendicular to the magnetization direction, the axial direction, or another direction.

In the above examples, the rotary electric machine 10 and the magnetic gear 20, 20A, 20B, 20C are a radial type in which a magnetic gap is formed in a direction perpendicular to the rotary shaft. However, the same effects are obtained also in an axial type in which a magnetic gap is formed in a direction parallel to the rotary shaft.

In the above examples, the rotary electric machine 10 has eight poles and twelve slots. However, the same effects are obtained even with a configuration having other numbers of poles and slots, as long as the relationship between the number of poles of the rotor and the number of the pole pieces 29 of the magnetic gear 20, 20A, 20B, 20C satisfies the above-described condition as shown in the above embodiments.

In the above embodiment 1, the example in which the fewer-pole mechanism (inner magnet tube 23) of the magnetic gear 20 has eight poles, the more-pole mechanism (outer magnet tube 26) has forty poles, and the number of the pole pieces 29 is twenty-four, has been shown. However, for example, these numbers may be combined as follows.

Where a number Ns of poles of the fewer-pole mechanism is smaller than a number Nm of poles of the more-pole mechanism, Np is the number of the pole pieces 29, and 1 and m are natural numbers, (21−1) Np=Nm±(2 m−1) Ns is satisfied. Then, the numbers are combined so as to satisfy the reduction condition for torque pulsation as shown in the above embodiments. Also in this case, the same effects are obtained.

In the above embodiments, the teeth 16, the pole pieces 29, and the permanent magnets 13, 25, 28 of the rotary electric machine 10 and the magnetic gear 20, 20A, 20B, 20C have simplest shapes. However, the following shapes may be employed. For example, the teeth 16 and the pole pieces 29 may have shapes spreading or tapered toward the magnetic gap as extending in the radial direction. As the permanent magnets 13, 25, 28, bonded magnets may be used, or two or more permanent magnets may be used per one magnetic pole and may be embedded in a V shape. In any case, the same effects are obtained as long as pole arrangements relevant to magnetic gaps have relationships similar to those in the above embodiments.

Although the disclosure is described above in terms of various exemplary embodiments and implementations, it should be understood that the various features, aspects, and functionality described in one or more of the individual embodiments are not limited in their applicability to the particular embodiment with which they are described, but instead can be applied, alone or in various combinations to one or more of the embodiments of the disclosure.

It is therefore understood that numerous modifications which have not been exemplified can be devised without departing from the scope of the present disclosure. For example, at least one of the constituent components may be modified, added, or eliminated. At least one of the constituent components mentioned in at least one of the preferred embodiments may be selected and combined with the constituent components mentioned in another preferred embodiment.

### DESCRIPTION OF THE REFERENCE CHARACTERS

10, 10A rotary electric machine
11 rotary shaft
12, 12A rotor
13 permanent magnet
15 stator
16 tooth
20, 20A, 20B, 20C magnetic gear
21 input portion
22 output portion
23, 23A, 23B inner magnet tube
25 first permanent magnet
26, 26A outer magnet tube
28 second permanent magnet
29 pole piece
30, 30A, 30B magnetic material tube
31 magnetic gap
100, 100A, 100B, 100C magnetic gear device
θ, φ phase shift

1. A magnetic gear device comprising:
a magnetic gear including an inner magnet tube having a plurality of first permanent magnets arranged at an outer circumference to form a fewer-pole mechanism, an outer magnet tube having a plurality of second permanent magnets arranged at an inner circumference to form a more-pole mechanism, and a magnetic material tube provided between the inner magnet tube and the outer magnet tube with magnetic gaps interposed from both of the inner magnet tube and the outer magnet tube, the magnetic material tube having N pole pieces made of a soft magnetic material and arranged with equal intervals therebetween in a circumferential direction, such that one of the inner magnet tube, the outer magnet tube, and the magnetic material tube is used as a first rotor connected to an input portion, another one is used as a second rotor connected to an output portion, and a remaining one is used as a stator; and
a rotary electric machine including a rotor having M1 permanent magnets and a stator having M2 teeth, wherein
the magnetic gear is configured such that the input portion is connected to a rotary shaft of the rotary electric machine and an inputted rotational force is transmitted to the output portion, and
at least one of a first condition that a first value based on a least common multiple of the number N of the pole pieces and a number of poles of one of the first and second rotors coincides with a least common multiple M of M1 and M2, and a second condition that the first value coincides with a value obtained by multiplying M1 by a multiple of 3, is satisfied.

2. The magnetic gear device according to claim 1, wherein
a phase between a circumferential-direction magnetic pole center of the rotor and a circumferential-direction center position of the tooth of the rotary electric machine when a circumferential-direction magnetic pole center of the first rotor coincides with a circumferential-direction magnetic pole center of the stator of the magnetic gear, is adjusted so that torque pulsation of the rotary electric machine and torque pulsation of the magnetic gear are reduced with each other.

3. The magnetic gear device according to claim 1, wherein
the magnetic material tube is used as the stator of the magnetic gear, and
the least common multiple of the number N of the pole pieces and the number of poles of the first rotor is the first value.

4. The magnetic gear device according to claim 3, wherein
when a circumferential-direction magnetic pole center of the first rotor coincides with a circumferential-direction center position of the pole piece which is a magnetic pole of the stator, a circumferential-direction magnetic pole center of the rotor of the rotary electric machine is phase-shifted from a circumferential-direction center position of the tooth by a set angle, so that torque pulsation of the rotary electric machine and torque pulsation of the magnetic gear are reduced with each other.

5. The magnetic gear device according to claim 4, wherein
the set angle is greater than (360/M/6) degrees and smaller than ((360/M/6)×5) degrees.

6. The magnetic gear device according to claim 1, wherein
the magnetic material tube is used as the second rotor of the magnetic gear, and
a value obtained by multiplying the least common multiple of the number N of the pole pieces and the number of poles of the first rotor by ((a number of poles of the stator)/N) is the first value.

7. The magnetic gear device according to claim 1, wherein
the number of poles of the first rotor≥M1 is satisfied.

8. The magnetic gear device according to claim 7, wherein
the number of poles of the first rotor=M1 is satisfied.

9. The magnetic gear device according to claim 1, wherein
the magnetic material tube is used as the first rotor of the magnetic gear, and
a value obtained by multiplying the least common multiple of the number N of the pole pieces and the number of poles of the second rotor by ((a number of poles of the stator)/N) is the first value.

10. The magnetic gear device according to claim 9, wherein
N≥M2 is satisfied.

11. The magnetic gear device according to claim 1, wherein
the input portion of the magnetic gear is formed integrally with the rotary shaft of the rotary electric machine.

12. The magnetic gear device according to claim 2, wherein
the magnetic material tube is used as the stator of the magnetic gear, and
the least common multiple of the number N of the pole pieces and the number of poles of the first rotor is the first value.

13. The magnetic gear device according to claim 12, wherein
when a circumferential-direction magnetic pole center of the first rotor coincides with a circumferential-direction center position of the pole piece which is a magnetic pole of the stator, a circumferential-direction magnetic pole center of the rotor of the rotary electric machine is phase-shifted from a circumferential-direction center position of the tooth by a set angle, so that torque pulsation of the rotary electric machine and torque pulsation of the magnetic gear are reduced with each other.

14. The magnetic gear device according to claim 13, wherein
the set angle is greater than (360/M/6) degrees and smaller than ((360/M/6)×5) degrees.

15. The magnetic gear device according to claim 2, wherein
the magnetic material tube is used as the second rotor of the magnetic gear, and
a value obtained by multiplying the least common multiple of the number N of the pole pieces and the number of poles of the first rotor by ((a number of poles of the stator)/N) is the first value.

16. The magnetic gear device according to claim 2, wherein
the number of poles of the first rotor≥M1 is satisfied.

17. The magnetic gear device according to claim 16, wherein
the number of poles of the first rotor=M1 is satisfied.

18. The magnetic gear device according to claim 2, wherein
the magnetic material tube is used as the first rotor of the magnetic gear, and
a value obtained by multiplying the least common multiple of the number N of the pole pieces and the number of poles of the second rotor by ((a number of poles of the stator)/N) is the first value.

19. The magnetic gear device according to claim 18, wherein
N≥M2 is satisfied.

20. The magnetic gear device according to claim 2, wherein
the input portion of the magnetic gear is formed integrally with the rotary shaft of the rotary electric machine.
